(19) United States
(12) Patent Application Publication
(10) Pub. No.: US 2018/0321069 A1
(43) Pub. Date: Nov. 8, 2018

(54) DEVICE FOR DELIVERING METERED QUANTITIES OF A LIQUID OR PASTY PRODUCT

(71) Applicant: ERCA, Les Ulis (FR)

(72) Inventor: Bernard GANDON, Ponthevrard (FR)

(21) Appl. No.: 15/772,295

(22) PCT Filed: Oct. 25, 2016
(86) PCT No.: PCT/FR2016/052764

§ 371 Date: Apr. 30, 2018

(30) Foreign Application Priority Data
Nov. 2, 2015 (FR) 1560456
Nov. 13, 2015 (FR) 1560899

(51) Int. Cl. G01F 11/02

(52) U.S. Cl. CPC G01F 11/021

(57) ABSTRACT

The device comprises at least one piece of equipment that has a metering chamber (38) in which a piston (26) is mounted to move back and forth between a filling position and a discharge position. The metering chamber is, at least in part, defined inside a cylinder (24) in which the piston moves, which is disposed in a substance reservoir (10), and which is itself mounted to move back and forth between an open position in which a feed opening (36) of the cylinder is opened up and a closed position in which the feed opening is closed off. The piston is connected to a controlled back-and-forth movement mechanism.

The present specification relates to a device for dispensing metered quantities of a liquid or semi-liquid substance, the device comprising at least one piece of substance metering and dispensing equipment that has a metering chamber in which a piston is mounted to move back and forth between a substance filling position and a substance discharge position.

In the meaning of the present specification, the liquid or semi-liquid substance is a substance that behaves substantially like a fluid that is more or less viscous, and that can be dispensed as a liquid or as a paste, via a nozzle. In particular, such a substance is a foodstuff, such as a beverage, a yoghurt, a compote, or the like. However, the substance may contain “bits” enveloped in the fluid. For example, such bits are pieces of fruit or cereals. Such bits can be solid, such as cereals or dried fruit, or indeed semi-solid, such as non-dried fruit, marshmallow, or a substance of like consistency.

A device of this type is known from French Patent Application No. 2 945 798. In that known device, the metering chamber has inlets and outlets situated at the same end of the chamber, the inlet and the outlet being opened up and closed off in turn by means of a rotary gate, thereby respectively allowing the chamber to be fed when the piston is in the filling position, and allowing substance to be discharged when the piston moves towards its discharge position.

That known device is generally satisfactory, but its dynamic behavior is particular, making it necessary to combine and to synchronize the back-and-forth movement of the piston and the rotary movement of the gate. In addition, it is sometimes difficult to use when it is necessary to meter out certain types of substances, in particular substances having high viscosity or containing solid or semi-solid bits that are of relatively large size, and, in particular, that have a maximum diametrical size of about one centimeter. For a substance having high viscosity, substance admission via the opening in the gate when it is in register with the inlet of the chamber, and substance discharge via that opening when it is in register with the outlet of the chamber can sometimes be difficult to achieve at high throughput rates, if the dimensions of the opening are not large enough. Unfortunately, when a rotary gate is used, the opening in the gate is necessarily of relatively small size so as to enable it to be fully masked or fully open in turn. In addition, when the substance contains solid or semi-solid bits, such bits can jam in the opening, either while the chamber is being fed, or while substance is being discharged, which poses operating problems.

There is therefore a need to improve the device of the above-mentioned type, facilitating dispensing not only of liquid or low-viscosity substances but also of very viscous substances or indeed of substances containing bits.

In addition, Patent Application US 2010/0072229 discloses a liquid substance dispenser including an assembly made up of first and second pistons separated from each other by a separation spring, the second piston forming a cylinder in which the first piston can move. That assembly is disposed in a reservoir. Under the effect of a return spring disposed between the first piston and the outlet of the reservoir, the assembly is moved upwards to enable the metering chamber that is situated under the first piston to be filled via an opening in the wall of the cylinder, which opening is then opened up. Under the effect of the hydrostatic pressure in the reservoir, the assembly is then urged downwards to close off that opening. Then, the separation spring moves the first piston away from the second piston, so that the first piston pushes back the substance so as to dispense it.

That system is complicated to implement because the relative stiffness and the relative strokes of the two pistons must be chosen carefully. It is also necessary to adjust and to vary the hydrostatic pressure in the reservoir by means of a pressurizing gas, in order to enable the assembly comprising the two pistons to move back up after dispensing the substance, and then to move back down after the metering chamber has been filled, even though the filling has, in principle, caused the pressure in the reservoir to decrease. In addition, the volume of substance that is to be dispensed cannot be modified because the strokes of the springs are not readily modifiable. Furthermore, that device cannot be used for dispensing a substance that is very viscous or that contains bits because such a substance could adversely affect the springiness of the springs by becoming jammed between their turns. Finally, it is difficult to clean the device properly, and in particular to clean the springs properly.

An object of the invention is to propose a device for metering out a substance of the above-mentioned type that is entirely or partially free of the drawbacks of the above-mentioned state of the art.

Thus, the present specification provides a device for dispensing metered quantities of a liquid or semi-liquid substance, the device comprising at least one piece of substance metering and dispensing equipment that has a metering chamber in which a piston is mounted to move back and forth between a filling position in which substance is fed via a feed opening and a discharge position in which substance is discharged via a substance outlet, the metering chamber being, at least in part, defined inside a cylinder having a feed opening and in which the piston moves, the cylinder being disposed in a substance reservoir, and itself being mounted to move back and forth between an open position in which the feed opening is opened up and a closed position in which the feed opening is closed off, the piston having a head carried by a control rod that passes through an extension of the cylinder and that is connected to a piston movement mechanism suitable for being controlled to cause the piston to move back and forth.

The dynamic behavior of the device is thus extremely simple, since both the piston and the cylinder move axially back and forth in translation, so as to make it possible for the feed opening of the cylinder and thus of the metering chamber to be opened up and closed in alternation. Said opening may have large dimensions, as a function of the position reached by the cylinder in the open position. In addition, the volume of the metering chamber may be adjusted by modifying the movement stroke of the piston.

Optionally, the cylinder is connected by an arm to a cylinder movement mechanism suitable for being controlled to cause the cylinder to move back and forth.

The dimensions of the opening can be adjusted easily by modifying the stroke of the back-and-forth movement of the cylinder. The risk of bits becoming jammed in the opening is thus extremely low. In addition, even if bits do become jammed, they are easily sheared when the cylinder is moved into its closed position, so that they do not block the opening durably. At least when the cylinder is in the closed position, it communicates at its end remote from the piston, with a substance outlet that makes it possible to expel substance from the metering chamber.

The above-mentioned rod and arms may extend in part inside the reservoir; said elements may be formed by parts that are of simple geometrical shape and that are therefore easy to clean.

Optionally, the rod extends remote from the substance outlet. Optionally, the arm extends remote from the substance outlet.

Optionally, the equipment has a first closure surface that is secured to the reservoir, and the cylinder has a second closure surface, the first and second closure surfaces co-operating with each other in the closed position so as to close off the feed opening and being spaced apart from each other in the open position.

In the open position, the feed opening is formed or opened up due to the closure surfaces being spaced apart.

Optionally, the second closure surface is situated at one end of the cylinder.

Optionally, the cylinder carries at least one guide member that co-operates with a guide surface secured to the reservoir while the cylinder is moving between its open and closed positions.

Optionally, the guide member is formed by at least one extension of the second closure surface.

Optionally, the metering chamber also includes a cavity that is secured to and in alignment with the cylinder.

Optionally, the feed opening is formed between the cylinder and an edge of the cavity when the cylinder is in the open position.

Optionally, the first closure surface is formed on an inside surface of the cavity.

Optionally, the metering chamber has a substance outlet equipped with an outlet valve.

Optionally, the substance outlet is disposed at one end of the cavity.

The invention can be well understood and its advantages appear more clearly on reading the following detailed description of an embodiment that is shown by way of non-limiting example. The description refers to the accompanying drawings, in which:

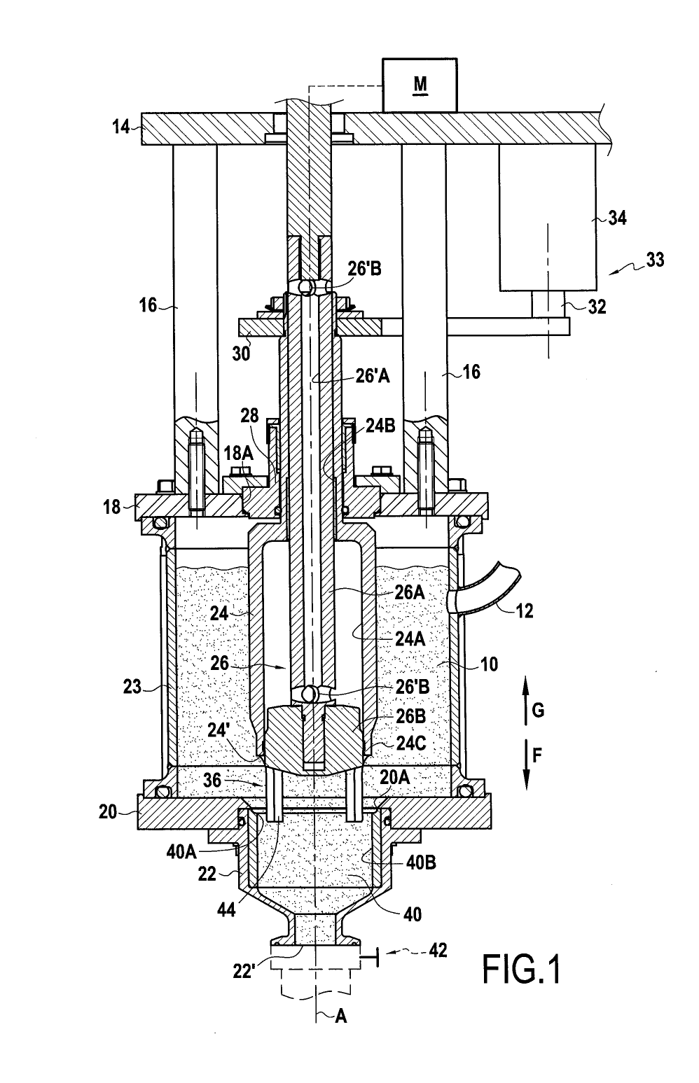

FIG. 1 is an axial section view of an equipment of the invention, showing the situation at the beginning of the stage of filling the cylinder with substance;

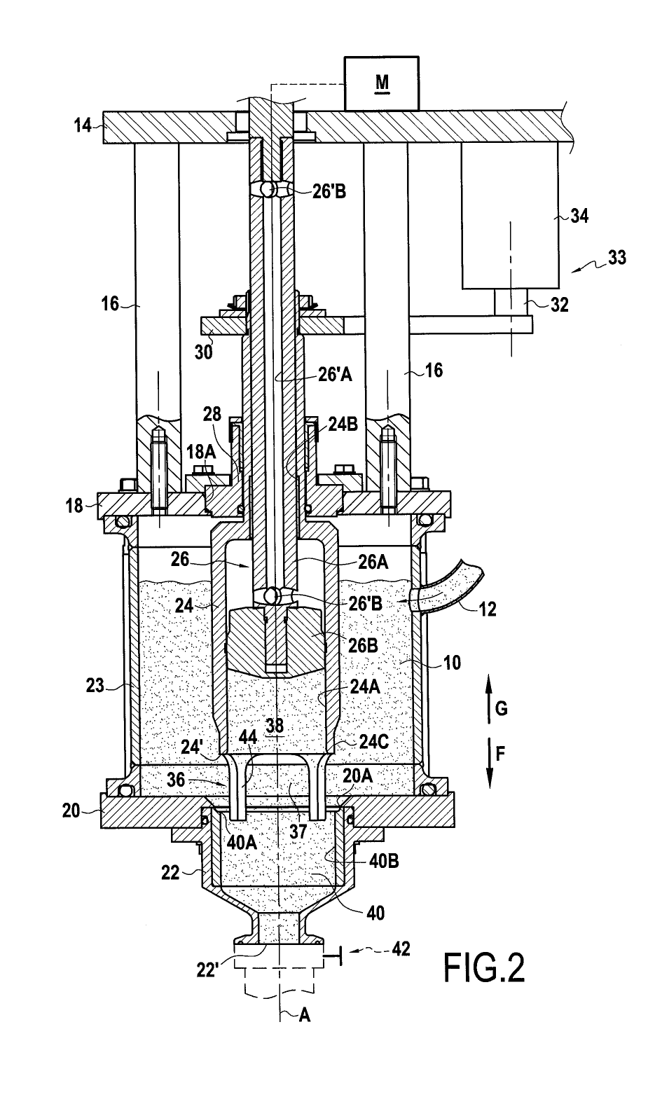

FIG. 2 is a view analogous to the FIG. 1 view, showing the situation while the cylinder is being filled with substance;

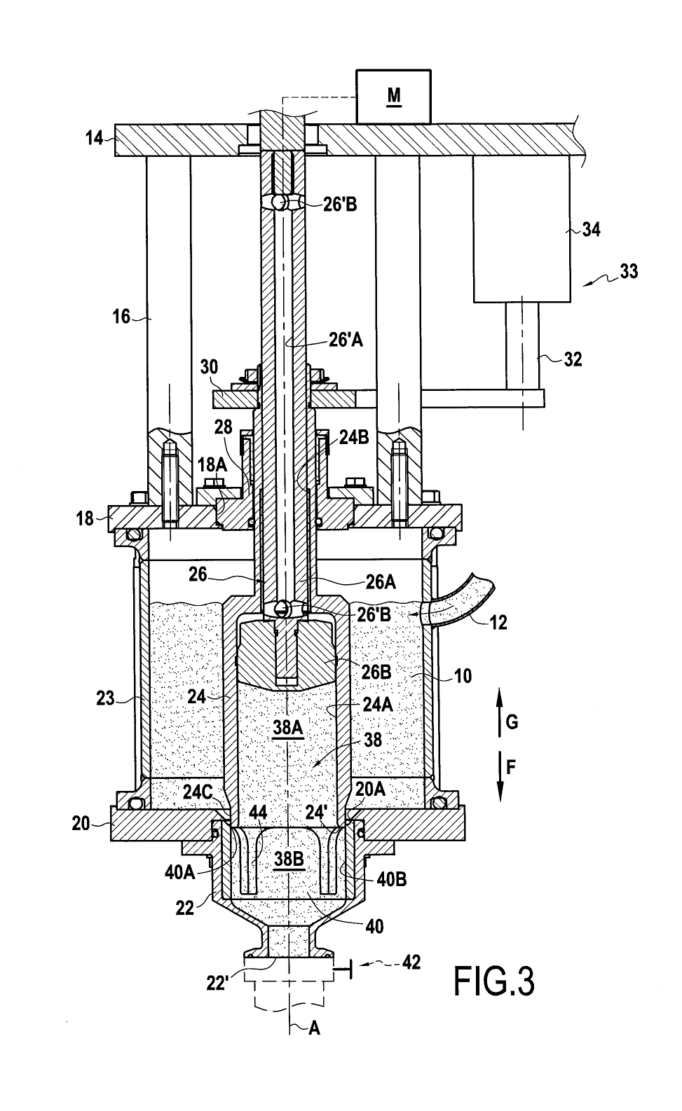

FIG. 3 is a view analogous to the views of FIGS. 1 and 2, showing the situation at the beginning of the stage for discharging the substance after the cylinder has been filled; and

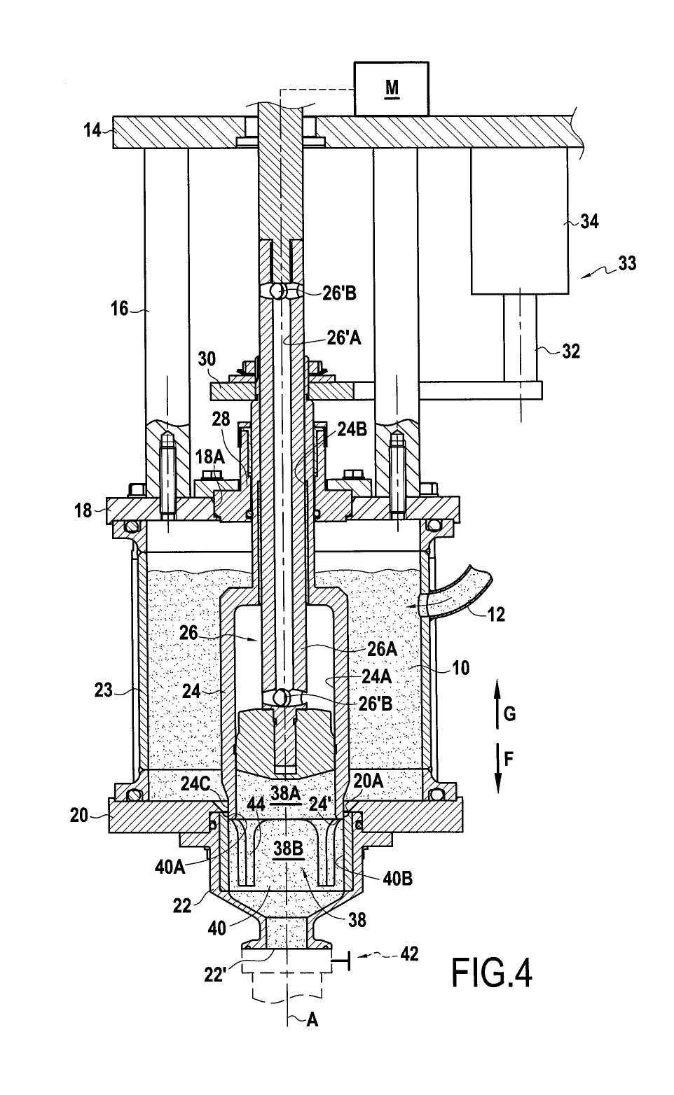

FIG. 4 is a view analogous to the views of FIGS. 1 to 3, showing the situation at the end of the stage for discharging the substance.

The figures show a device for dispensing quantities of liquid or semi-liquid substance, which device comprises a reservoir 10, fed with substance to be metered out via an inlet 12. In this example, said reservoir is supported by a support plate 14, to which it is fastened (e.g. by being suspended) by rods 16. In this example, the reservoir is defined between an upper plate 18 fastened to the support rods 16, a lower plate 20 that carries an outlet end-piece 22 for the substance, and a side wall 23 that extends between the plates 18 and 20. The plate 20 is provided with an opening 20A, in which the outlet of the reservoir 10 is formed and that communicates with the outlet end-piece 22. The cylinder 24 is aligned with said opening.

Inside the reservoir, a cylinder 24 is disposed in which a piston 26 is mounted to move back and forth. The piston 26 includes a rod 26A that passes through an extension of the cylinder; in this example, the rod passes through a tubular extension 24B of the cylinder 24. In this example, this tubular extension 24B passes through a bore 18A in the upper plate 18, so that it can slide in a sliding bearing 28 disposed in said opening 18A. The piston 26 also has a head 26B, carried by the rod 26A and suitable for sliding against the inside cylindrical wall 24A of the cylinder 24. In this example, the rod 26A has an inside bore 26′A having its end that is further away from the cylinder connected to ambient air via one or more openings 26′B while the other end, situated in the cylinder behind the head 26B, is connected to the inside space of the cylinder 24 via one or more bores 26′B. In this example, the “rear” position is to be understood in contrast to the direction in which the head 26B moves forward inside the cylinder 24 in the direction F in which the substance contained in said cylinder is discharged. In a variant, clearance may be provided between the outside surface of the rod and the inside surface of the tubular extension 24B of the cylinder, in which extension it slides. Thus, the space pointed to by the line leading from reference 24B in FIG. 1 may be formed by one or more longitudinal grooves for balancing the pressure between the inside and the outside of the cylinder, at the end remote from the head 26B of the piston 26.

The rod 26A of the piston is connected to a piston movement mechanism M, carried, in this example, by the support plate 14 and suitable for causing said rod to move back and forth. This mechanism M may be of any known type that can be controlled by a control unit; e.g. said mechanism may be an electric motor having a belt or a worm screw, or indeed it may be an actuator. Thus, the piston is mounted to move axially back and forth in the direction F in which the substance is discharged from the piston (in this example downwards) and in the direction G in which the piston retracts into the cylinder (in this example upwards) making it possible to feed the cylinder with substance.

The rod 26A of the piston passes through the tubular extension 24B of the cylinder 24. It can be seen that this tubular extension 24B is carried by an arm 30 that, in this example, is itself connected to the support plate 14 by a mechanism 33 for moving the cylinder back and forth. In this example, said mechanism comprises an actuator having its rod 32 connected to the arm 30 and its body 34 carried by the support plate 14. For example, it is a hydraulic or compressed air actuator. Naturally, any other back-and-forth movement means that can be controlled by a control unit may be devised, such as, for example an electric motor having a belt or a worm screw. By means of this mechanism, the cylinder 24 can also be moved axially back and forth, in respective ones of the above-mentioned directions F and G. In this example, the arm 30 is attached to the tubular extension 24B of the cylinder. It could be secured rigidly to any other portion of the cylinder. In this example, the arm 30 is outside the reservoir, because the tubular extension 24B itself extends out of the reservoir. However, the arm could be disposed in part inside the reservoir.

FIG. 1 shows a situation in which the piston is in a discharge position in which it discharges substance from the cylinder, its head 26B being situated at the end of the cylinder that is remote from the arm 30. In FIG. 1, the cylinder 24 is in an open position in which a feed opening 36 of the cylinder is opened up. More precisely, the opening is provided at the end 24′ of the cylinder 24 that is remote from the tubular extension 24B and from the arm 30. In FIG. 1, it can be seen that said end 24′ is spaced apart from the plate 20, thereby opening up the opening 36 and enabling substance to pass into the outlet end-piece 22.

In FIG. 2, the cylinder 24 is in the same position as in FIG. 1, but the piston 26 has started to move in the direction G, towards its filling position. It can be understood that, during this movement, the substance going through the opening 36 penetrates into the cylinder via its end 24′, which is open.

In FIG. 3, the piston has reached the filling position in which the cylinder is filled with substance, and in which the piston is the furthest away from the end 24′ of the cylinder. However, the cylinder has itself moved in the direction F to reach its closed position in which the feed opening 36 of the cylinder is closed. At this stage, the metering chamber 38 is closed. This chamber comprises a first portion 38A formed by the inside volume of the cylinder that is situated between its end 24′A and the head 26B of the piston, and a second portion 38B formed in a cavity 40 that is secured to the reservoir. In this example, said cavity 40 is formed in a portion of the outlet end-piece 22. As indicated, the cylinder 24 is aligned with the opening 20A in the plate 20, so that the cavity 40 is situated in alignment with the cylinder.

The outlet end-piece 22 is provided with an outlet valve 42, e.g. formed by a diaphragm or by any by any other suitable means. During the feed stage in which the cylinder is fed with substance and which is shown in FIGS. 1 and 2, said valve 42 is closed. It opens as from the instant at which the feed opening 36 of the cylinder via which the cylinder is fed with substance is closed, i.e. once the piston has reached its filling position and the cylinder has reached its closed position, as shown in FIG. 3. Thus, in FIG. 4, the valve 42 is open, and the piston is moving in the direction F, towards its discharge position in which it discharges substance from the cylinder. The metered volume of substance in the metering chamber 38 is therefore then discharged from said chamber via the outlet end-piece 22, e.g. so as to fill receptacles such as yoghurt pots or the like. The metered volume of substance corresponds to the inside volume of the first portion 38A of the metering chamber that is defined, inside the cylinder, by the stroke of the piston.

Once the metered substance in said portion 38A has been fully discharged via the outlet end-piece 22, the valve 42 of which is open, i.e. once the head 26A of the piston has reached its end position shown in FIG. 1 while the cylinder is in this closed position shown in FIG. 4, the valve 42 is closed, and a new cycle can start.

Thus, each metering cycle comprises the following operations in succession:
closing the valve 42;
moving the cylinder and the piston in the direction G, until the cylinder has reached its open position and until the piston has reached its filling position;
moving the cylinder into its closed position, while the piston remains in its filling position;
opening the valve 42; and
moving the piston in the direction F until it reaches its discharge position in which it discharges substance from the cylinder.

Naturally, actuation of the various mechanisms that are necessary for implementing this cycle, in particular the control for opening the valve 42, the mechanism M for moving the piston, and the mechanism 33 for moving the cylinder, may be controlled and synchronized by a control unit such as an electronic control unit (ECU), programmed to control the above-mentioned sequence of operations. The ECU may act directly on the mechanism M for moving the piston and on the mechanism 33 for moving the cylinder, i.e. it may give them on/off instructions. The use of a control unit makes it possible to perform these cycles of sequences at high rates.

In FIGS. 3 and 4, it can be seen that the opening 36 (visible in FIGS. 1 and 2) is closed off by co-operation between a first closure surface 40A secured to the reservoir 10 and a second closure surface 24C secured to the cylinder 24. In this example, the first closure surface 40A is formed by a portion of the inside cylindrical surface of the cavity 40, while the second closure surface 24C is formed by a cylindrical portion of the outside periphery of the cylinder 24, close to its end 24′. It can be seen in FIGS. 3 and 4 that the two surfaces co-operate with each other in shear, since they overlap axially and are in sliding contact or almost sliding contact, in order to close the opening 36. In contrast, in FIGS. 1 and 2, said closure surfaces are spaced apart from each other and the opening 36 is thus formed. Closure surfaces extending axially and co-operating axially as in the example shown offer the advantage of closing the opening 36 effectively at very high rates of movement of the cylinder without having to come into abutment in any precise position, but naturally provision could be made for the closure surfaces to have a component perpendicular to the movement axis A of the piston and of the cylinder.

It can also be seen in the figures that the cylinder 24 carries guide members 44 that co-operate with a guide surface that is secured to the reservoir. In this example, said guide surface is formed on the inside cylindrical surface 40B of the cavity 40. Thus, in this example, the above-mentioned first closure surface 40A and the guide surface 40B form the same surface. In this example, the cylinder carries a plurality of guide members 44 formed by extensions of the above-mentioned second closure surface 24C. These extensions form leg-like members that extend the cylinder beyond its edge 24′. It can be seen that the legs may be spaced very widely apart so that, when the opening 36 is formed, the passageways 37 of large section are formed between the legs 44, which makes it possible to feed the metering chamber quickly even if the substance is very viscous, or if it contains bits that are solid to a greater or lesser extent.

In this example, these legs or extensions 44 co-operate continuously with the guide surface 40A, 40B, since it can be seen that they overlap that surface axially both when the cylinder is in its open position (see FIGS. 1 and 2) and when it is in its closed position (see FIGS. 3 and 4).

Naturally, it is possible to reverse the configuration shown, by implementing the legs as extensions of the wall of the cavity 40 that penetrate into the cylinder. In such a configuration, the guide member in the meaning of the present specification would be formed by an axial surface of the cylinder in the vicinity of its end 24′, e.g. its outside axial surface, and the guide surface would be formed by an axial surface of each of the extensions, e.g. their inside axial surfaces.

As indicated above, the reservoir has an outlet end-piece 22 that is connected to the plate 20 provided with a through hole. The outlet 22′ of said end-piece thus forms a substance outlet for the metering chamber. Said outlet 22′, disposed at the end of the cavity 40 that is remote from the cylinder 24, is equipped with the valve 42, downstream from which an outlet nozzle (not shown) is situated.

The device of the invention may comprise one or more pieces of substance metering and dispensing equipment. If it comprises more than one piece of equipment, their respective cylinders may naturally be disposed in the same reservoir or in distinct reservoirs. In addition, if there is more than one piece of equipment, they may be carried by the same support plate 14 or by different plates; the same arm 30 and the same mechanism 33 may be provided for carrying and moving their respective cylinders, or else each of them may have its own cylinder support arm and its own cylinder movement mechanism; the same mechanism M may serve to move their respective pistons, or else each of them may have its own piston movement mechanism. For example, it is possible to have one support arm common to the various cylinders, which arm is disposed in a common reservoir and is rigidly secured to a control rod that extends out of the common reservoir so as to be connected to the cylinder movement mechanism. The axial bearing for guiding the cylinders in translation may co-operate with said control rod. Similarly, when a common movement mechanism is used for more than one piston, the rods of said pistons may be secured to the same piston support arm, which arm is moved back-and-forth by the movement mechanism.

It is also possible to provide upstream guide means such as a surface co-operating with the cylinder support arms 30 so as to guide the movement of said arm while it is moving back and forth. For example, said upstream guide surface is formed on a guide rod that is carried by a stationary element, e.g. by the support plate 14, and that passes through a bore in the arm 30. Said guide surface may, in particular, be used when the arm is common to a plurality of cylinders, as explained below. It may also facilitate guiding of the piston. In particular, the same guide rod may be used to guide the movement of the piston support arm, when such an arm is present.

In the meaning of the present specification, the cylinder may be disposed entirely inside the reservoir or else be disposed only partially inside the reservoir. It suffices for the opening 36 formed when the cylinder is in the open position to be fed with substance situated in the reservoir.

1. A device for dispensing metered quantities of a liquid or semi-liquid substance, the device comprising at least one piece of substance metering and dispensing equipment that has a metering chamber in which a piston is mounted to move back and forth between a filling position in which substance is fed via a feed opening and a discharge position in which substance is discharged via a substance outlet, the metering chamber being, at least in part, defined inside a cylinder having a feed opening and in which the piston moves, the cylinder being disposed in a substance reservoir, and itself being mounted to move back and forth between an open position in which the feed opening is opened up and a closed position in which the feed opening is closed off
the piston having a head carried by a control rod that passes through an extension of the cylinder and that is connected to a piston movement mechanism suitable for being controlled to cause the piston to move back and forth.

2. A device according to claim 1, wherein the cylinder is connected by an arm to a cylinder movement mechanism suitable for being controlled to cause the cylinder to move back and forth.

3. A device according to claim 2, wherein the piston movement mechanism and the cylinder movement mechanism are controlled by an electronic control unit.

4. A device according to claim 1, wherein the rod and/or the arm extend remote from the substance outlet.

5. A device according to claim 1, wherein the equipment has a first closure surface that is fixedly connected to the reservoir, and the cylinder has a second closure surface, the first and second closure surfaces co-operating with each other in the closed position so as to close off the feed opening and being spaced apart from each other in the open position.

6. A device according to claim 1, wherein the second closure surface is situated at one end of the cylinder.

7. A device according to claim 5, wherein the cylinder carries at least one guide member that co-operates with a guide surface secured to the reservoir while the cylinder is moving between its open and closed positions.

8. A device according to claim 7, wherein the guide member is formed by at least one extension of the second closure surface.

9. A device according to claim 1, wherein the metering chamber also includes a cavity that is secured to and in alignment with the cylinder.

10. A device according to claim 9, wherein the feed opening is formed between the cylinder and an edge of the cavity when the cylinder is in the open position.

11. A device according to claim 2, wherein the metering chamber also includes a cavity that is secured to and in alignment with the cylinder, the feed opening is formed between the cylinder and an edge of the cavity when the cylinder is in the open positions and first closure surface is formed on an inside surface of the cavity.

12. A device according to claim 1, wherein the metering chamber has a substance outlet equipped with an outlet valve.

13. A device according to claim 10, wherein the substance outlet is disposed at one end of the cavity.
